(19) United States
(12) Patent Application Publication
(10) Pub. No.: US 2012/0100985 A1
(43) Pub. Date: Apr. 26, 2012

(54) PROCESS FOR THE PREPARATION OF A PHOTOCATALYST

(75) Inventors: Alexandra Seeber, Lambsheim (GB); Goetz-Peter Schindler, Ludwigshafen (DE); Florina Corina Patcas, Ludwigshafen (DE); Günter Heinz Bruno Kreisel, Jena (DE); Susan Schaefer, Trockenborn (DE); Sarah Anna Sabrowski, Hattersheim (DE); Doreen Keil, Jena (DE)

(73) Assignee: BASF SE, Ludwigshafen (DE)

(21) Appl. No.: 13/381,786

(22) PCT Filed: Jun. 30, 2010
(86) PCT No.: PCT/EP2010/059312

§ 371 Date: Dec. 30, 2011

(30) Foreign Application Priority Data
Jul. 1, 2009 (EP) 09164330.4

(51) Int. Cl. B01J 21/06

(52) U.S. Cl. 502/5

(57) ABSTRACT

The present invention relates to a process for the preparation of a photocatalyst P comprising a substrate, coated with at least one photocatalytically active metal oxide, and at least one cocatalyst, comprising at least the steps:
(A) electrochemical treatment of the at least one substrate with an electrolyte comprising at least one precursor compound of the at least one photocatalytically active metal oxide in order to obtain a substrate coated with at least one photocatalytically active metal oxide and
(B) photochemical treatment of the substrate, coated with at least one photocatalytically active metal oxide, in a further electrolyte comprising at least one precursor compound of the at least one cocatalyst in order to obtain the photocatalyst P.

The present invention relates to a process for the preparation of a photocatalyst P comprising a substrate, coated with at least one photocatalytically active metal oxide, and at least one cocatalyst, comprising at least the steps (A) electrochemical treatment of the at least one substrate in an electrolyte comprising at least one precursor compound of the at least one photocatalytically active metal oxide in order to obtain a substrate coated with at least one photocatalytically active metal oxide and (B) photochemical treatment of the substrate, coated with at least one photocatalytically active metal oxide, in a further electrolyte comprising at least one precursor compound of the at least one cocatalyst in order to obtain the photocatalyst P.

Processes for the preparation of photocatalysts in which a photocatalytically active material is applied to a corresponding substrate are already known from the prior art.

DE 198 41 650 A1 discloses a process for the preparation of nanocrystalline metal oxide and mixed metal oxide layers on metals forming a barrier layer, in which the coating by anodization with spark discharge in an electrolyte which comprises at least one or more complexing agents, preferably chelating agents, one or more metal alkoxides and at least one alcohol, preferably secondary or tertiary alcohols. According to DE 198 41 650 A1, predetermined layer properties, in particular with regard to adhesive strength, semiconductor effect, surface character, photo- and electrochromism, and with regard to catalytic activity, individually or in their combination, can be achieved by suitable choice of the concentration ranges of the electrolysis bath components and by the adjustable parameters of the anodization process. This document furthermore discloses that the properties of the photocatalytically active layers obtained can be additionally influenced by adding further components, such as, for example, iron ions or ruthenium ions, electrically neutral micro- or nanoparticles, etc., to the electrolyte of the anodization in order to introduce said components into the photocatalytically active layer.

DE 10 2005 043 865 A1 relates to a further development of the process according to DE 198 41 650 A1 already cited. In order further to increase the photocatalytic activity of the layers obtained, according to DE 10 2005 043 865 A1, for example gadolinium(III) acetylacetonate hydrate and/or cerium(III) acetylacetonate hydrate, in a concentration of less than 0.01 mol/l, and optionally further components are added to the electrolyte in which the anodization of the substrate is carried out.

DE 10 2005 050 075 A1 discloses a process for depositing metals, preferably noble metals, on firmly bonded metal oxide and mixed metal oxide layers. For this purpose, a corresponding substrate is first provided with a metal oxide or a mixed metal oxide layer. The metal cations present in this oxide layer are then reduced in their valency by an electrochemical treatment; for example, titanium⁴⁺ is reduced to titanium³⁺. The substrate which is treated in this manner and has an oxide layer and in which metal cations are present in reduced form is then treated with an aqueous solution in which preferably noble metals in oxidized form are present. Owing to the reduction potentials of the noble metal cations or of the metal cations present in the oxide layer, the metals are deposited from the aqueous solution onto the oxide layer in elemental form while at the same time the reduced metal cations present in the oxide layer are converted into their original oxidized form, i.e. titanium³⁺ to titanium⁴⁺. The amount of elemental metal which is present on or in the oxide layer after this process has been carried out can be adjusted by the extent to which the metal cations are reduced in the oxide layer by the electrochemical treatment at the beginning of the process.

Photocatalysts which are still in need of improvement with regard to their activity when used in photocatalyzed reactions, for example in the preparation of hydrogen from alcohols, are obtainable by said processes of the prior art. Furthermore, there is a need for a process for the preparation of photocatalysts which are distinguished by particularly high activity, it being necessary for the process to be particularly easy to carry out and to give the corresponding photocatalysts in constant high and reproducible quality. Furthermore, it is intended to provide a corresponding process which is distinguished in that the amount of cocatalyst which is present on the photocatalyst can be adjusted in a particularly sensitive and predetermined manner.

These objects are achieved by the process according to the invention for the preparation of a photocatalyst P comprising a substrate, coated with at least one photocatalytically active metal oxide, and at least one cocatalyst, comprising at least the layers:
(A) electrochemical treatment of the at least one substrate with an electrolyte comprising at least one precursor compound of the at least one photocatalytically active metal oxide in order to obtain a substrate coated with at least one photocatalytically active metal oxide and
(B) photochemical treatment of the substrate, coated with at least one photocatalytically active metal oxide, in a further electrolyte comprising at least one precursor compound of the at least one cocatalyst in order to obtain the photocatalyst P.

The process according to the invention serves for the preparation of a photocatalyst P comprising a substrate, coated with at least one photocatalytically active metal oxide, and at least one cocatalyst.

According to the invention, the photocatalyst P comprises a substrate. In general, all substrates which can be coated with at least one photocatalytically active metal oxide are suitable for the process according to the invention. In a preferred embodiment of the process according to the invention, the substrate is selected from the group consisting of metals, semiconductors, glass substrates, ceramic substrates, cellulose fibers and plastics substrates, preferably electrically conductive plastics substrates, and mixtures or alloys thereof. The substrate is particularly preferably a metal selected from the group consisting of titanium, aluminum, zirconium, tantalum and further materials forming a barrier layer and mixtures or alloys thereof.

In a particularly preferred embodiment, the substrate of the photocatalyst P which can be prepared according to the invention is a sheet-like metal, for example a metal sheet or a metal net. According to the invention, the substrate may have all possible shapes and surface characteristics. According to the invention, the substrates may be planar, curved, for example convex or concave, symmetrically or asymmetrically shaped. The surface of the substrate used may be smooth and/or porous. Processes for the optionally performed pretreatment of the surface of the metal substrates are known to a person skilled in the art, for example cleaning, ultrasound, polishing.

The substrate which can be used according to the invention may have all dimensions which are known to the person skilled in the art and have sufficient electrical conductivity. Regarding the width, thickness and length of the substrates which can be used according to the invention, there are no general limitations; for example, rectangular or square substrates having edge lengths of from 0.5 to 100 mm, in particular from 5 to 50 mm, are used. Rectangular metal substrates having the dimensions from 5 to 10 mm×from 60 to 100 mm are very particularly preferably used.

For the preparation of the photocatalyst P, the substrate in step (A) is coated with at least one photocatalytically active metal oxide. According to the invention, it is possible to use all photocatalytically active metal oxides which are known to the person skilled in the art and have semiconductor properties, for example titanium dioxide, zinc oxide, zirconium dioxide, tantalum oxide, hafnium dioxide and mixtures thereof. In a particularly preferred embodiment, the photocatalytically active metal oxide is titanium dioxide, which may be present in the anatase or rutile modification or a mixture thereof or in the amorphous state.

The layer formed according to the invention on the substrate and comprising at least one photocatalytically active metal oxide has a layer thickness which in general is not subject to any limitation. For example, the layer of photocatalytically active metal oxide has a layer thickness of from 1 to 200 μm, preferably from 5 to 150 μm, particularly preferably from 10 to 80 μm. Methods for determining the layer thickness are known to the person skilled in the art, for example by the eddy current method (DIN EN ISO 2360, DIN 50984) using a Surfix® layer thickness meter (from Phynix).

The layer present on the substrate generally has a BET specific surface area of from 10 to 200 m²/g, preferably from 20 to 100 m²/g, particularly preferably from 30 to 80 m²/g. Methods for determining the specific surface are known to the person skilled in the art, for example according to Brunauer-Emmett-Teller (BET) from the N₂ adsorption isotherm (DIN 66131).

The average pore size of the titanium dioxide preferably used as photocatalytically active metal oxide is in general from 0.1 to 20 nm, preferably from 1 to 15 nm, particularly preferably from 2.5 to 10 nm. Methods for determining the pore size are known to persons skilled in the part, for example the BJH method.

The photocatalyst P prepared by the process according to the invention comprises at least one cocatalyst. In a preferred embodiment of the process according to the invention, the at least one cocatalyst is selected from groups 3 to 12 of the Periodic Table of the Elements (according to IUPAC), lanthanoids, actinoids and mixtures thereof, preferably from the group consisting of V, Zr, Ce, Zn, Au, Ag, Cu, Pd, Pt, Ru, Rh, La and mixtures thereof, very particularly preferably Pd, Cu or Pt or mixtures thereof. The cocatalyst present on the photocatalyst P prepared according to the invention may be present in elemental form or as a compound, preferably as an oxide. The palladium preferably present as a cocatalyst is preferably present in elemental form. The copper present as a cocatalyst in a further preferred embodiment is preferably present as copper(I) oxide Cu₂O.

The at least one cocatalyst is present on the photocatalyst P in an amount which is sufficient to impart to the photocatalyst P a sufficiently high photocatalytic activity, for example from 0.001 to 5% by weight, preferably from 0.01 to 1% by weight, particularly preferably from 0.1 to 0.5% by weight, based in each case on the total photocatalyst P.

Below, the individual steps of the process according to the invention for the preparation of a photocatalyst P are described in detail:

Step (A):

Step (A) of the process according to the invention comprises the electrochemical treatment of the at least one substrate in an electrolyte comprising at least one precursor compound of the at least one photocatalytically active metal oxide in order to obtain a substrate coated with at least one photocatalytically active metal oxide.

In principle, step (A) of the process according to the invention is carried out according to the process described in DE 198 41 650 A1. The disclosure of DE 198 41 650 A1 is therefore a part of this invention in its entirety.

In a preferred embodiment, the electrochemical treatment in step (A) is an anodization, particularly preferably an anodization with spark discharge. For this purpose, in general at least one substrate is introduced into a corresponding electrolyte and subjected to an electrochemical treatment.

The electrolyte used in step (A) generally comprises the components which are necessary for the production of a layer of at least one photocatalytically active metal oxide. In a preferred embodiment, an aqueous electrolyte is used in step (A) of the process according to the invention, i.e. the solvent used is water.

In a preferred embodiment, the preferably aqueous electrolyte according to step (A) comprises one or more of the following components selected from the group consisting of complexing agents, alcohols and mixtures thereof.

Preferred complexing agents are N-chelating agents having at least one ═N—CH₂—COOH radical, for example selected from the group consisting of ethylene-diamine tetraacetate disodium salt (EDTA-Na₂), nitrilotriacetate trisodium salt (NTA-Na₃) and mixtures thereof. At least one complexing agent, for example in a concentration of from 0.01 to 5 mol/l, preferably from 0.05 to 2 mol/l, particularly preferably from 0.075 to 0.125 mol/l, is present in the electrolyte used in step (A) of the process according to the invention.

The preferably aqueous electrolyte used in step (A) of the process according to the invention preferably comprises at least one alcohol, preferably secondary or tertiary alcohols, for example isopropanol, or mixtures thereof, for example in a concentration of from 0.01 to 5 mol/l, preferably from 0.02 to 2 mol/l, particularly preferably from 0.55 to 0.75 mol/l.

For the preferred case where titanium dioxide is applied as photocatalytically active metal oxide to the substrate, at least one titanium alkoxide, for example tetraethyl orthotitanate or a mixture thereof, is preferably used in the electrolyte in step (A) of the process according to the invention.

The at least one precursor compound of the at least one photocatalytically active metal oxide, in particular the at least one titanium alkoxylate, is present in general in a concentration which enables step (A) to be carried out in an advantageous manner, preferably in a concentration of from 0.01 to 5 mol/l, preferably from 0.02 to 1 mol/l, for example from 0.04 to 0.1 mol/l.

Furthermore, further additives known to the person skilled in the art may be present in the electrolyte according to step (A), for example buffer substances, preferably salts selected from the group consisting of ammonium hydroxide, ammonium acetate and mixtures thereof. These are added, for example, in order to keep the pH of the electrolyte in an appropriate range during the process. The optionally present pH buffer substances are present in the amounts in which they give the corresponding desired pH; preferably, these compounds are present in concentrations of from 0.001 to 0.1 mol/l, particularly preferably from 0.005 to 0.008 mol/l.

In a further preferred embodiment, further solvents, for example ketones, such as acetone, may also be present in the electrolyte in addition to water. These additional solvents are preferably present in an amount of from 0.01 to 2 mol/l, preferably from 0.2 to 0.8 mol/l, particularly preferably from 0.3 to 0.7 mol/l.

The electrochemical treatment by anodization with spark discharge is known in principle to the person skilled in the art. Below, the preferred process parameters of step (A) of the process according to the invention are mentioned.

In step (A) of the process according to the invention, the duty factor (t_{current}/t_{currentless}) vt is in general from 0.1 to 1.0, preferably from 0.3 to 0.7. The frequency f is in general from 1.0 to 2.0 kHz, preferably from 1.2 to 1.8 kHz. The voltage scan rate dU/dt in step (A) of the process according to the invention is in general from 10 to 100 V/s, preferably from 15 to 50 V/s, particularly preferably from 25 to 40 V/s. Step (A) is generally carried out at a voltage of from 10 to 500 V, preferably from 100 to 450 V, particularly preferably from 150 to 400 V. The coating time in step (A) of the process according to the invention is dependent on substrate size and is, for example, from 10 to 500 s, preferably from 50 to 200 s, particularly preferably from 75 to 150 s. In step (A) of the process according to the invention, the current I is generally from 0.5 to 100 A, preferably from 1 to 50 A, particularly preferably from 2 to 25 A.

The amount of at least one photocatalytically active metal oxide deposited in step (A) of the process according to the invention is dependent on the preparation parameters set and is, for example, from 1 to 50 mg/cm². The layer produced in step (A) and comprising at least one photocatalytically active metal oxide generally has the properties described above. Further details in this context appear in DE 198 41 650 A1.

In a preferred embodiment of the process according to the invention, the substrate is degreased before step (A). Methods for this purpose are known to the person skilled in the art; for example, the substrate can be treated with an aqueous solution comprising at least one surface-active substance, optionally with simultaneous heating and/or action of ultrasound. After treatment with such an aqueous solution, the degreased substrate can be washed with a suitable solvent, preferably water, before the electrochemical treatment according to step (A).

According to step (A) of the process according to the invention, a substrate coated with at least one photocatalytically active metal oxide is obtained. According to the invention, this can be used directly in step (B). According to the invention, it is also possible for the substrate according to step (A) to be washed with a suitable solvent, preferably water. Furthermore, it is possible and preferable to subject the coated substrate obtained according to step (A) to a thermal treatment, for example at a temperature of from 100 to 600° C., preferably from 200 to 500° C., particularly preferably from 300 to 450° C. The thermal treatment of the coated substrate is carried out in general for a sufficiently long time, for example from 0.1 to 5 hours, preferably from 0.5 to 3 hours. The thermal treatment can be effected at constant or increasing temperature. According to the invention, an increase in temperature is realized, for example, at a heating rate of from 15 to 30° C./min. The present invention therefore also relates to a process according to the invention in which the coated substrate obtained according to step (A) is thermally treated.

Step (B):

Step (B) of the process according to the invention comprises the photochemical treatment of the substrate, coated with at least one photocatalytically active metal oxide, in a further electrolyte comprising at least one precursor compound of the at least one cocatalyst in order to obtain the catalyst P.

In general, the further electrolyte according to step (B) of the process according to the invention comprises all components which are necessary for applying at least one cocatalyst according to step (B) of the process according to the invention to the substrate coated with at least one photocatalytically active metal oxide.

Suitable cocatalysts are mentioned above. Suitable precursor compounds for these cocatalysts are in general all compounds which can be converted into the corresponding cocatalysts under the conditions present in step (B) of the process according to the invention. For example salts and/or complex compounds of the abovementioned metals preferably used as cocatalysts may be mentioned as suitable precursor compounds for the at least one cocatalyst. Examples of particularly suitable salts are salts of organic mono- or dicarboxylic acids, in particular formates, acetates, propionates and oxalates, or mixtures thereof. Halides, for example fluorides, chlorides, bromides, nitrates and sulfates or mixtures thereof are also suitable. Acetates or halides, in particular chlorides, are particularly preferably used as precursor compounds for the at least one cocatalyst in step (B). Very particularly preferred precursor compounds for the at least one cocatalyst are selected from the group consisting of Cu(OOCCH₃)₂, K₂PdCl₄, HAuCl₄, K₂PtCl₄, IrCl₃ and mixtures thereof. This at least one precursor compound is present in general in a concentration of from 0.1 to 20 mmol/l, preferably from 0.5 to 1 mmol/l, in the electrolyte according to step (B) of the process according to the invention.

An aqueous electrolyte is preferably used in step (B), i.e. the solvent used for the electrolyte according to step (B) is water. In addition to the at least one precursor compound of the at least one cocatalyst, further additives known to the person skilled in the art are optionally present in the electrolyte according to step (B). For example, the precursor compounds present in the electrolyte according to step (B) are stabilized by addition of an acid, for example HNO₃, for example in a concentration of from 0.1 to 10% by volume.

The photochemical treatment according to step (B) of the process according to the invention is preferably effected by exposure to light, in particular UV light. In the context of the present invention, UV light is understood as meaning high-energy electromagnetic radiation, in particular light having a wavelength of from 200 to 400 nm. According to the invention, the UV light preferably used in step (B) is generated by appropriate UV lamps, for example Xe(Hg) arc lamp, diode arrays and combinations thereof. According to the invention, it is also possible to use other high-energy electromagnetic radiation which also has other wavelengths in addition to the preferred wavelengths. The light intensity, in particular of the UV radiation, in step (B) is in general from 0.1 to 30 mW/cm², preferably from 0.5 to 10 mW/cm², particularly preferably from 2 to 5 mW/cm².

Step (B) of the process according to the invention is carried out, for example, by bringing the substrate obtained from step (A), which is coated with at least one photocatalytically active metal oxide, into contact with the electrolyte according to step (B) in an appropriate reactor. According to the invention, any reactor known to a person skilled in the art, for example a cell, can be used as the reactor. In particular, a reactor which is transparent for the wavelength range of the UV light used is employed.

The at least one UV light source is set up at an appropriate distance from the cell in order to expose the substrate in the electrolyte according to step (B) to UV light. The exposure is carried out for a period which is sufficient to apply a sufficient amount of cocatalyst to the substrate, for example from 1 to 200 min, preferably from 1 to 30 min, particularly preferably from 3 to 10 min.

In step (B), the at least one cocatalyst is applied to the layer present on the at least one substrate and comprising at least one photocatalytically active metal oxide. For example, from 30 to 80 μg, preferably from 40 to 60 μg, particularly preferably 55 μg, of Pd (0.52 μmol) or from 30 to 80 μg, preferably from 40 to 60 μg, particularly preferably 57 μg, of Cu (0.90 μmol) are deposited on a substrate measuring 0.8 cm×4 cm in one hour.

The present invention is illustrated in more detail by the following examples.

### EXAMPLES

### Example 1

### Coating with Titanium Dioxide (Step (A))

According to the invention, an aluminum sheet or a titanium sheet, in each case 0.8 cm×4 cm, is coated with titanium dioxide according to the process from DE 198 41 650. The electrochemical coating is followed by a thermal treatment at a temperature of 400° C. and a heating rate of 20° C./min. The process parameters and the properties of these coated substrates are reproduced in table 1.

TABLE 1

| | Titanium substrate | | Aluminum substrate | |
|---|---|---|---|---|
| Duty factor vt | 0.5 | | 0.5 | |
| Frequency f | 1.5 | kHz | 1.5 | kHz |
| Voltage scan rate dU/dt | 30 | V/s | 30 | V/s |
| Voltage U | 180 | V | 360 | V |
| Coating time | 90 | s | 120 | s |
| Current | 10 | A | 10 | A |
| Amount of TiO₂ deposited | 8.5 mg (2.66 mg/cm²) | | 20 mg (6.25 mg/cm²) | |
| Layer thickness | 20 | μm | n.d. | |
| Rutile:Anatase phase ratio | 70:30 | | 70:30 | |
| Specific surface area S_{BET} | 45-60 | m²/g | 45-60 | m²/g |

| | | | |
|---|---|---|---|
| Average pore size | 37 | Å | n.d. |

n.d.—not determined

### Example 2

### Application of the Cocatalyst (Step (B))

The titanium substrate obtained according to example 1 and coated with titanium dioxide is subjected to photodeposition. For this purpose, a 300 watt Xe(Hg) arc lamp from L.O.T. Oriel is used. The light intensity is 2.3 mW/cm². The reaction vessel used is a cell having a layer thickness of 13 mm. 6 ml of the precursor solution are introduced into the cell. Copper(II) acetate Cu(OOCCH₃)₂ and potassium tetrachloropalladate K₂PdCl₄ are used as precursor compounds. H₂O is used as the solvent. In the case of K₂PdCl₄, 1% by volume of concentrated HNO₃ is added for stabilization. The results of the individual experiments are shown below.

### Example 2.1

| Cocatalyst | Cu₂O |
|---|---|
| Concentration of the precursor compound | 0.6 mm |
| in the precursor solution | |
| Exposure time | 5 min |
| Amount of cocatalyst on coated substrate | 0.15% by weight |

### Example 2.2

| Cocatalyst | Cu₂O | |
|---|---|---|
| Concentration of the precursor compound | 3.0 | mm |
| in the precursor solution | | |
| Exposure time | 1 | h |

| | |
|---|---|
| Amount of cocatalyst on coated substrate | 0.35% by weight |

### Example 2.3

| Cocatalyst | Pd | |
|---|---|---|
| Concentration of the precursor compound | 0.6 | mm |
| in the precursor solution | | |
| Exposure time | 5 | min |

| | |
|---|---|
| Amount of cocatalyst on coated substrate | 0.13% by weight |

### Example 2.4

| Cocatalyst | Pd | |
|---|---|---|
| Concentration of the precursor compound | 0.6 | mm |
| in the precursor solution | | |
| Exposure time | 16 | h |

| | |
|---|---|
| Amount of cocatalyst on coated substrate | 0.39% by weight |

### Example 3

### Determination of the Photocatalytic Activity

Description of Experiment

The carrier-fixed catalyst (0.8 cm×4 cm) and 3.3 ml of an aqueous CH₃OH solution (50% by volume) are introduced into a minireactor for determining the photocatalytic activity. The reaction mixture is flushed with argon for 5 min before the exposure. The reactor has a total volume of 9.3 ml and is exposed to a light intensity of 6 mW/cm² at 365±5 nm. In order to determine the amount of hydrogen formed, a 250 μl sample amount is taken from the gas space of the reactor every 15 min. This is analyzed for its hydrogen content in a gas chromatograph (Varian CP-3800; 5 Å molecular sieve; carrier gas: Ar).

| | m(TiO₂) | Cocatalyst | H₂ | H₂ |
|---|---|---|---|---|
| Catalyst | [mg/cm²] | [Gew.-%] | [μmol/(cm² h)] | [μmol/(g h)] |
| Example 2.1 | 2.7 | 0.15 | 1.9 | 706 |
| Example 2.2 | 2.7 | 0.35 | 2.0 | 768 |
| Example 2.3 | 2.7 | 0.13 | 6.3 | 2351 |
| Example 2.4 | 2.7 | 0.39 | 7.1 | 2636 |

1.-9. (canceled)

10. A process for the preparation of a photocatalyst P comprising a substrate, coated with titanium dioxide, and at least one cocatalyst, the process comprising:
(A) electrochemically treating the substrate in an electrolyte comprising at least one titanium alkoxide in order to obtain a substrate coated with titanium dioxide, and
(B) photochemically treating the substrate coated with titanium dioxide in a further electrolyte comprising at least one precursor compound of the at least one cocatalyst in order to obtain the photocatalyst P.

11. The process according to claim 10, wherein the electrochemical treatment in step (A) is an anodization.

12. The process according to claim 10, wherein the photochemical treatment in step (B) is effected by exposure to light.

13. The process according to claim 10, wherein the substrate is selected from the group consisting of metals, semiconductors, glass substrates, ceramic substrates, cellulose fibers, plastics substrates, and mixtures or alloys thereof.

14. The process according to claim 10, wherein the substrate is selected from the group consisting of metals, semiconductors, glass substrates, ceramic substrates, cellulose fibers, electrically conductive plastics substrates, and mixtures or alloys thereof.

15. The process according to claim 10, wherein the at least one cocatalyst is selected from groups 3 to 12 of the Periodic Table of the Elements (according to IUPAC), lanthanoids, actinoids and mixtures thereof.

16. The process according to claim 10, wherein the substrate coated with titanium dioxide obtained according to step (A) is thermally treated.

17. The process according to claim 10, wherein step (A) is carried out at a voltage of from 100 to 450 V.

18. The process according to claim 10, wherein the light intensity in step (B) is from 0.5 to 10 mW/cm².
